(19) United States
(12) Patent Application Publication
(10) Pub. No.: US 2006/0060395 A1
(43) Pub. Date: Mar. 23, 2006

(54) Track assembly for an all-terrain vehicle

(76) Inventors: Denis Boivin, Beaumont (CA); Alain Boivin, Levis (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/147,237

(22) Filed: Jun. 8, 2005

Related U.S. Application Data
(60) Provisional application No. 60/577,924, filed on Jun. 9, 2004.

(51) Int. Cl. B62D 55/00

(52) U.S. Cl. 180/9.21

(57) ABSTRACT

The present invention relates to a track assembly adapted to be retrofitted to an all-terrain vehicle having a driving output. The track assembly comprises an endless track belt extending over at least a pair of longitudinally spaced-apart inner wheels and a driving arrangement adapted to be drivingly connected to the driving output of the all-terrain vehicle for transmitting power to the endless track belt. The driving arrangement comprises at least one driving wheel mounted outside of a loop defined by the endless track belt and in driving engagement therewith. It also relates to a steering mechanism for an all-terrain vehicle having a pair of front track assemblies, each having at least one driving wheel.

### CROSS-REFERENCE TO RELATED APPLICATIONS

This application claims priority under 35USC§119(e) of U.S. provisional patent application 60/577,924, filed on Jun. 9, 2004, the specification of which is hereby incorporated by reference.

### BACKGROUND OF THE INVENTION

1) Field of the Invention

The present invention relates to all-terrain vehicles and, more particularly to track assemblies for all-terrain vehicles.

2) Description of the Prior Art

Traditionally, two types of all-terrain vehicles are proposed either the wheeled type or the tracked type. Wheeled vehicles are usually more maneuverable than tracked vehicles but are not as efficient on uneven or soft terrain such as snow.

Mainly two types of track systems have been proposed. U.S. Pat. No. 6,006,847 describes an endless track structure having a substantially triangular shape. An endless track belt is mounted over front and rear idler wheels and two spaced apart driving wheels mounted on the existing wheel hub of the vehicle. The idler wheels are located below the driving wheels and are interconnected with sliding shoes. The track belt of U.S. Pat. No. 6,006,847 has a wide supporting footprint. U.S. patent application Ser. No. 10/165,707 describes an endless track structure having also a substantially triangular shape wherein an endless track belt is mounted over front and rear idler wheels a driving wheel mounted on the existing wheel hub of the vehicle. However, the idler wheels are located above the driving wheel and therefore the track belt has a punctualized localized surface with the ground.

The track structure of U.S. Pat. No. 6,006,847 gives better performance when the vehicle is in deep snow conditions than the track structure of U.S. patent application Ser. No. 10/165,707. However, the performance of U.S. Pat. No. 6,006,847 decreases when the ground surface is harder. Moreover, since it includes sliding shoes, it can only be used in snow conditions. Since the track structure of U.S. patent application Ser. No. 10/165,707 does not have sliding shoes, it can be used on any ground surfaces.

There is therefore a need for a new track assembly for an all-terrain vehicle that gives as good performance as the track system of U.S. Pat. No. 6,006,847 in snow conditions and can be used on any ground surface.

### SUMMARY OF THE INVENTION

An object of the present invention is therefore to provide improved track assemblies for an all-terrain vehicle.

According to one aspect of the present invention, there is provided a straddle-type vehicle including at least one track assembly to support vehicle onto a ground surface. The at least one track assembly comprises a longitudinal endless track belt having an outer surface and an inner surface; a frame to mount the longitudinal endless track belt to the vehicle; at least one driving wheel disposed externally to the longitudinal endless track belt, the at least one driving wheel being in driving engagement with the longitudinal endless track belt; and at least two inner wheels in contact with the inner surface of the longitudinal endless track belt.

According to another aspect of the present invention, there is provided a track assembly for an all-terrain vehicle. The track assembly comprises a longitudinal endless track belt having an outer surface and an inner surface and a mounting structure to mount the longitudinal endless track belt to the vehicle. The mounting structure includes at least one driving wheel disposed externally to the longitudinal endless track belt, the at least one driving wheel being in driving engagement with the longitudinal endless track belt, and at least two inner wheels in contact with the inner surface of the longitudinal endless track belt.

According to a further aspect of the present invention, there is provided a mechanism for facilitating the steering of an all-terrain vehicle having a pair of track assemblies. Each track assembly has at least one driving wheel. The mechanism comprises at least one first and second braking systems operatively connected to respective driving wheels of the pair of track assemblies; the first and second braking systems being independently actuable, whereby upon activating one of the first and second braking systems, the driving wheel operatively associated with the actuated braking system is slowed down to facilitate turning of the vehicle in the direction of the slowed down driving wheel.

According to another aspect of the present invention, there is provided an all-terrain vehicle including a steering mechanism and a pair of front track assemblies. Each of the track assemblies comprises at least one driving wheel and at least one independent braking system operatively connected to the at least one driving wheel; the braking systems of the track assemblies being selectively independently actuable, whereby upon actuating one of the braking system, the driving wheel operatively associated with the actuated braking system slows down allowing the vehicle to turn in the direction of the slowed down driving wheel.

According to another aspect of the present invention, there is provided a method to facilitate the steering of an all-terrain vehicle having a pair of front track assemblies, each having at least one driving wheel. The method comprises providing at least first and second braking systems; operatively connecting the first and second braking systems to respective ones of the track assemblies; and providing independent control of the first and second braking systems.

According to another aspect of the present invention, there is provided a method to facilitate the steering of an all-terrain vehicle having a pair of left and right track assemblies. The left and right track assemblies respectively includes left and right driving wheels and left and right brakes. The method comprises the step of providing independent control of the left and right brakes, whereby upon independently actuating one of the left and right brakes, only the driving wheel associated to the actuated brake is slowed down creating a speed differential between the left and right track assemblies to facilitate steering of the vehicle in the direction of the slowed down driving wheel.

According to a still another aspect of the present invention, there is provided a track assembly adapted to be retrofitted to a straddle type vehicle having a driving output. The track assembly comprises an endless track belt extending over at least a pair of longitudinally spaced-apart inner wheels, and a driving arrangement adapted to be drivingly connected to the driving output of the straddle type vehicle for transmitting power to the endless track belt, wherein the driving arrangement comprises at least one driving wheel mounted outside of a loop defined by the endless track belt and in driving engagement therewith.

### BRIEF DESCRIPTION OF THE DRAWINGS

Further features and advantages of the present invention will become apparent from the following detailed description, taken in combination with the appended drawings, in which:

FIG. 1. is a side elevation view of an all-terrain vehicle provided with track assemblies according to a preferred embodiment of the present invention;

FIG. 2 is a photograph of an inside perspective view of a mounting structure according to the present invention, with a longitudinal endless track belt mounted thereon and wherein the mounting structure is mounted on an all-terrain vehicle;

FIG. 3 is an outside perspective view of the mounting structure according to the present invention, without the track belt;

FIG. 4 is an enlarged outside perspective view of the mounting structure according to the present invention, without the track belt;

FIG. 5 is an inside perspective view of the mounting structure according to the present invention, without the track belt;

FIG. 6 is a top plan view of the mounting structure according to the present invention, without the track belt;

FIG. 7 is a photograph of a front elevation view of the mounting structure according to the present invention, with the track belt mounted thereon and wherein the mounting structure is mounted on an all-terrain vehicle; and

FIG. 8 is a photograph of a top perspective view of the mounting structure according to the present invention, with the track belt mounted thereon and wherein the mounting structure is mounted on an all-terrain vehicle.

FIG. 9 is a side elevation view of an all-terrain vehicle provided with track assemblies according to a second embodiment of the present invention;

FIG. 10 is an inside perspective view of a mounting structure with a longitudinal endless track belt mounted thereon according to the present invention;

FIG. 11 a front elevation view of the mounting structure of FIG. 10 with the longitudinal endless track belt mounted thereon according to the present invention; and

FIG. 12 an outside perspective view of the mounting structure of FIG. 10 with the longitudinal endless track belt mounted thereon according to the present invention.

It will be noted that throughout the appended drawings, like features are identified by like reference numerals.

### DETAILED DESCRIPTION OF THE PREFERRED EMBODIMENT

A track assembly adapted to be retrofitted to a wheeled type all-terrain vehicle according to an embodiment of the present invention will now be described in details with reference to the appended drawings.

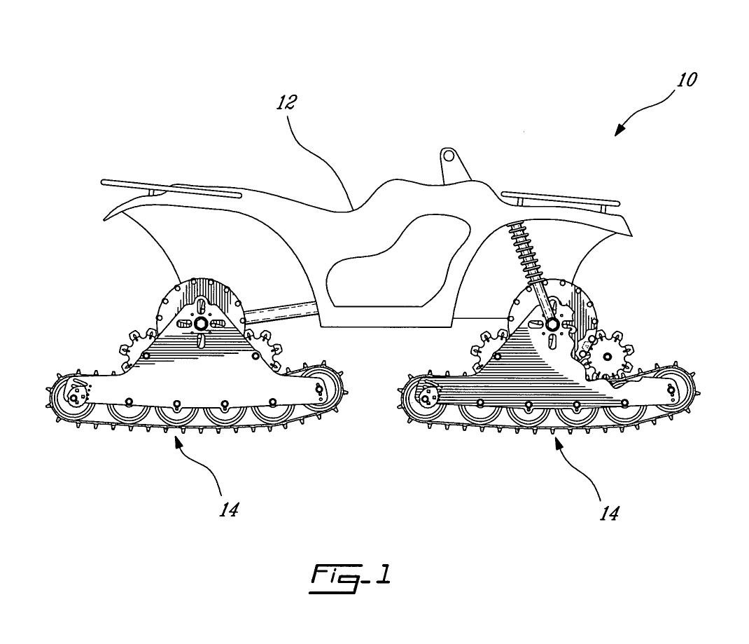

FIG. 1 shows an all-terrain vehicle 10 comprising a body 12 and four track assemblies 14 (only two are shown) arranged in a plane adjacent to each side of the vehicle 10. The four track assemblies 14 of the all-terrain vehicle 10 are identical and replace the conventional wheels of the all-terrain vehicle 10. Only one track assembly 14, visible in FIG. 1, will be described hereinbelow.

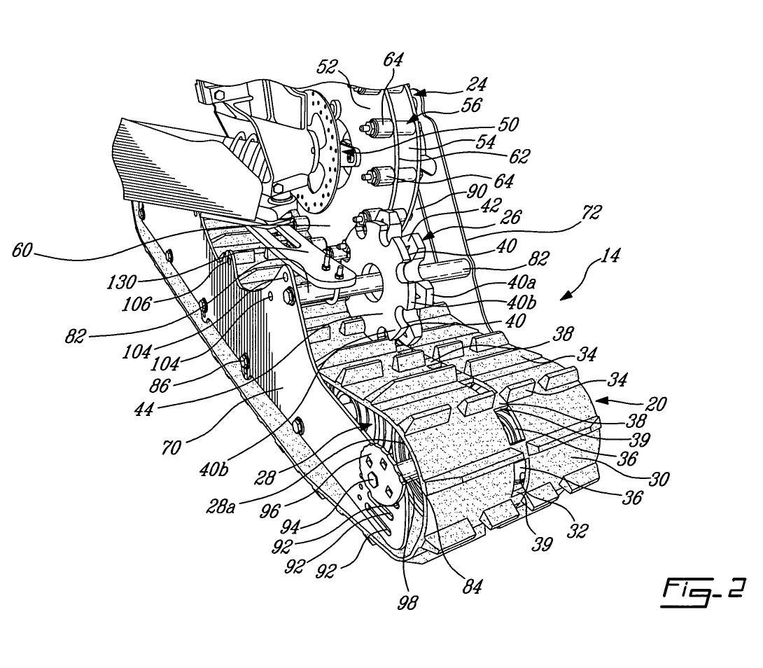

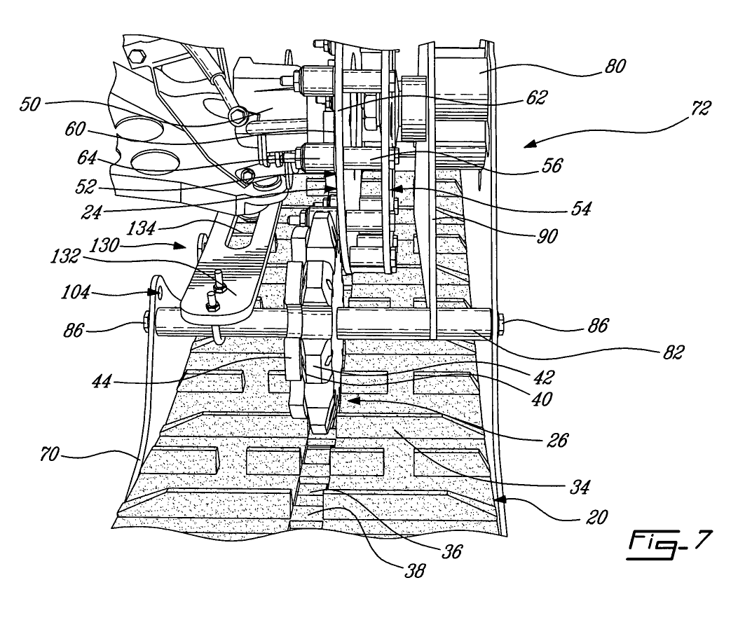

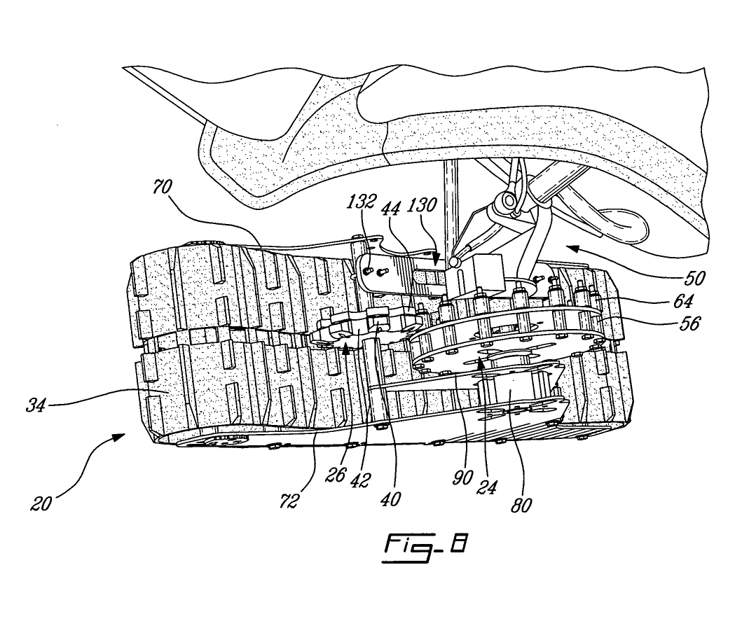

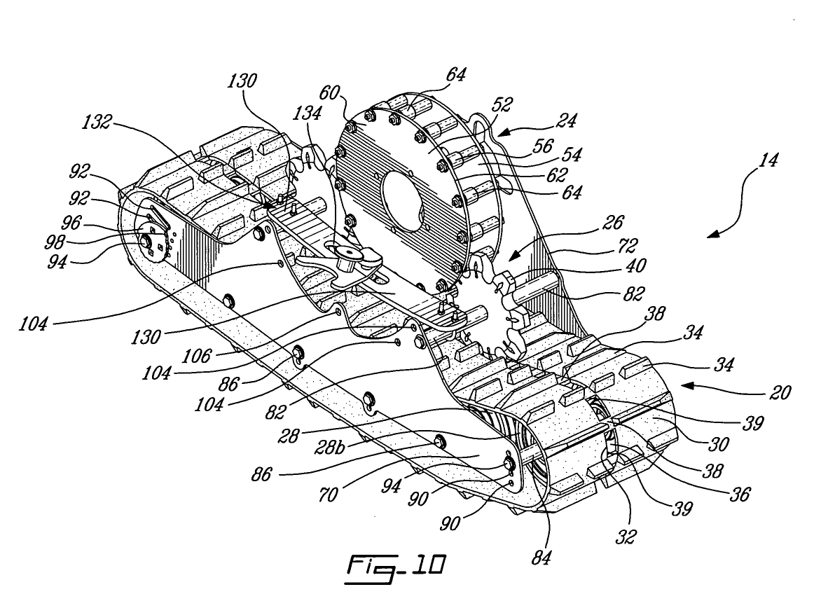

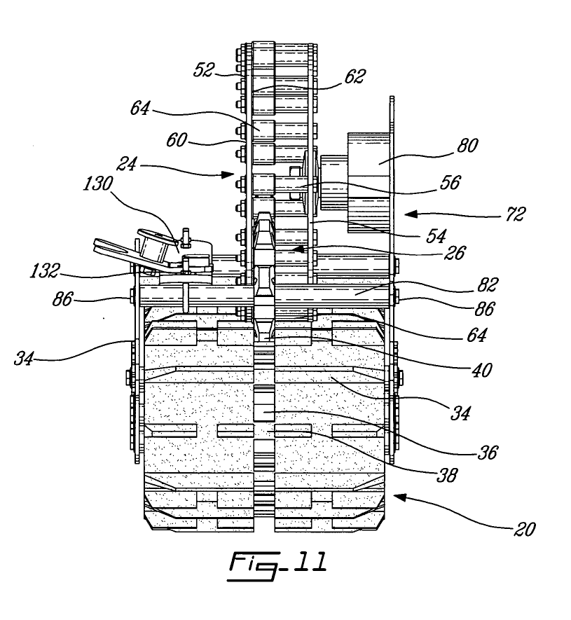

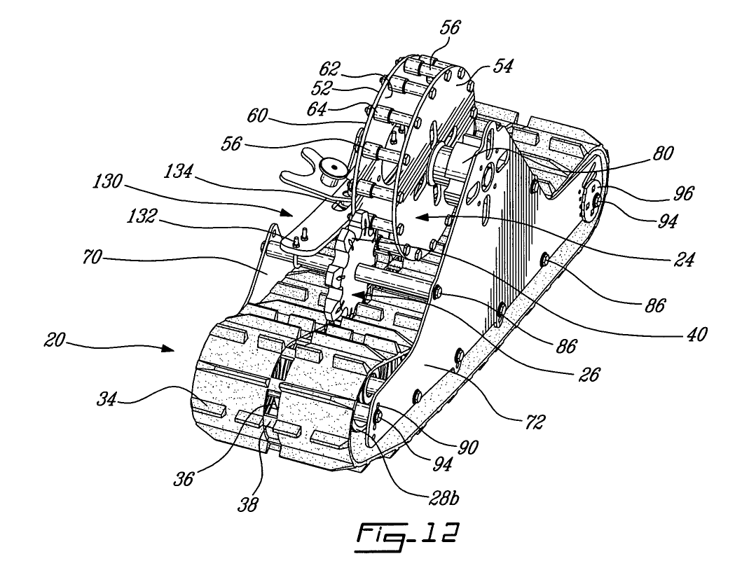

Referring to FIGS. 2 and 10, it will be seen that the track assembly 14 comprises a longitudinal endless track belt 20 and a mounting structure to mount the endless track belt 20 to the vehicle 10. The mounting structure includes a main driving wheel 24, a pair of track driving wheels 26 disposed on opposite sides of the rotation axis of the main driving wheel 24 (only one is shown in FIG. 2), and a plurality of inner idler wheels 28 disposed by pair inside longitudinal endless track belt 20, and supports to interconnect the wheels 24, 26 and 28 as will be described hereinbelow. The idler wheels 28 define two laterally spaced-apart rows of longitudinally spaced-apart wheels. As it can be seen from FIGS. 2, 7, 8, and 10-12, main driving wheel 24 and track driving wheels 26 are external to endless track belt 20.

Referring back to FIGS. 2 and 10, the endless track belt 20 is made of an elastomeric material and has an outer surface 30 for contact with the ground and an inner surface 32. Outer surface 30 is provided with transversal lugs 34 and is adapted to engage with the driving wheels 26 of the vehicle 10. The endless track belt 20 is also provided with equidistant longitudinally spaced-apart openings 36 for engagement with the track driving wheels 26. Adjacent openings 36 are separated by a bridging web 38. Bridging webs 38 are preferably covered with a reinforcing member 39 to increase the life expectancy of the endless track belt 20. The endless track belt 20 is wounded around the inner idler wheels 28 while the main driving wheel 24 and the track driving wheels 26 are located outside the loop defined by endless track belt 20.

Referring now simultaneously to FIGS. 2 to 4, 10, it will be seen that track driving wheels 26 are preferably provided in the form of cogwheels with equidistant teeth 40.

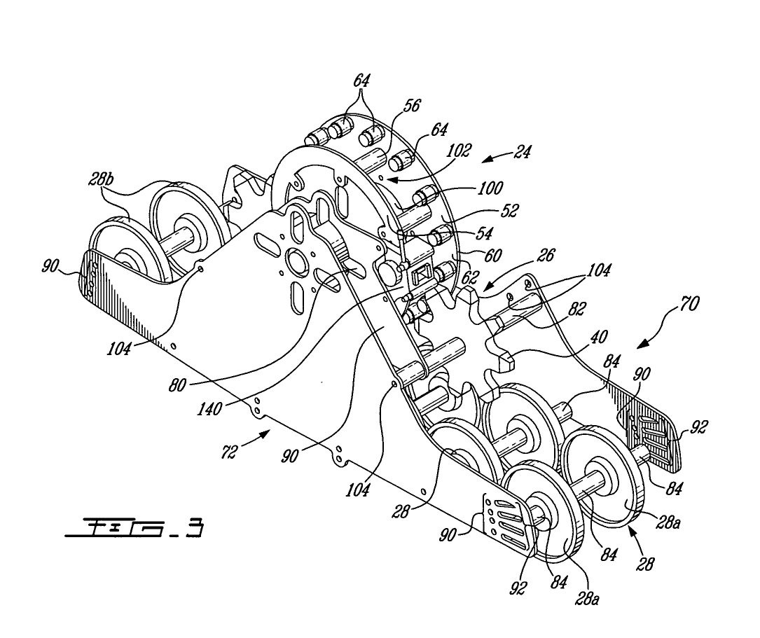

In the embodiment of FIG. 2, track driving wheels 26 are separated in two members. A first member 42 has teeth 40a that cooperates with the transversal lugs 34 provided on the outer surface 30 of the endless track belt 20 while a second member 44 has teeth 40b that cooperates with bridging webs 38 between openings 36. Teeth 40a, 40b are spaced so that the distance between two consecutive teeth 40a, 40b spans the distance separating consecutive transversal lugs 34 and bridging webs 38 respectively, in a meshing engagement, in such a way as to drive the endless track belt 20. As it will be easily understood by one skilled in the art, the track driving wheel 26 can have only one member (FIGS. 3, 4, and 10-12) that cooperates with either transversal lugs 34 of the endless track belt 20 or bridging webs 38, whichever the endless track belt 20 includes. In the embodiment of FIG. 10, track driving wheels 26 cooperate with bridging webs 38 between openings 36. Teeth 40 are spaced so that the distance between two consecutive teeth 40 spans the distance separating consecutive transversal lugs 34 and/or bridging webs 38 respectively, in a meshing engagement, in such a way as to drive the endless track belt 20.

The main driving wheel 24 is retrofitted to the existing hub 50 of the all-terrain vehicle 10 (FIG. 2). Referring simultaneously to FIGS. 2-4, and 10, it will be seen that the main driving wheel 24 includes an inside plate 52 mounted to the hub 50 and an outside plate 54 mounted to the inside plate 52 via a bolt and spacer assembly 56. Inside plate 52 has an outer surface 60 and an inner surface 62. A plurality of uniformly circumferentially distributed engaging members 64 are provided on either the outer surface 60 (FIG. 2) or the inner surface 62 (FIGS. 3-5) of inside plate 52. Engaging members 64 cooperate with the teeth 40 of track driving wheels 26. Equidistant engaging members 64 are spaced so that the distance between two consecutive engaging members 64 spans the distance separating consecutive teeth 40, in a meshing engagement, in such a way as to drive track driving wheels 26. As it will be easily understood by one skilled in the art, engaging members 64 can also be the spacers between the inside and outside plates 52, 54 (FIGS. 10-12) or be mounted on either the inner or outer surface of outside plate 54. According to one embodiment of the present invention, the engaging members 64 are provided in the form of rollers to provide a smooth torque transmission from the main driving wheel 24 to the track driving wheel 26.

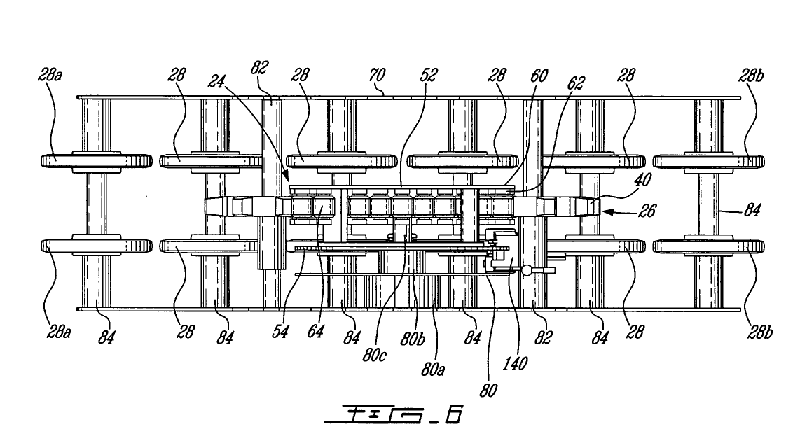

Wheels 24, 26 and 28 are interconnected with an inside mounting plate 70 and an outside mounting plate 72, wheels 24 and 26 being disposed externally to track belt 20. Inside plate 52 of main driving wheel 24 is connected to outside mounting plate 70 with a spacer 80. Referring to FIG. 6, it will be seen that spacer 80 has three portions 80a, 80b, and 80c, each portion having a different diameter. Inside plate 52 is rotatably mounted on spacer 80. Referring back to FIGS. 2-4, 10 and 12, it will be seen that each track driving wheels 26 is rotatably mounted on a spacer 82 which connects inside and outside mounting plates 70, 72. Similarly, each pair of inner idler wheels 28 is rotatably mounted on a spacer 84 which connects inside and outside mounting plates 70, 72. Spacers 80, 82, and 84 are fastened to inside and outside mounting plates 70, 72 with fasteners 86 inserted in apertures in inside and outside mounting plates 70, 72 but they could be welded thereon without departing from the scope of the invention. A reinforcing plate 90 (FIGS. 2-5) can interconnect spacer 80 and spacers 82. Reinforcing plate 90 reinforces outside plate mounting 72 and stiffens the track assembly 14.

Each of the inner idler wheels 28 has a peripheral portion in contact with the inner surface 32 of the track belt 20. In a preferred embodiment, track assembly 14 has a plurality of pairs of inner idler wheels 28. Each pair is rotatably mounted on each spacer 84. Moreover, any number of inner idler wheels 28 can be rotatably mounted on each spacer 84 without departing from the scope of the invention.

As it will be easily understood by one skilled in the art upon inspection of FIGS. 2, 3, 10, and 12, the shape of the endless track belt 20 can be modified by adjusting the vertical position of the front and rear idler wheels 28a, 28b. As it can be seen, both ends of inside and outside mounting plates 70, 72 have several round apertures 91, at various height, in which spacer 84 can be fastened. By mounting spacer 84 in a higher round aperture 91 positioned at one end, endless track belt 20 has a C-shape at that end as seen in FIGS. 2 and 10. On the opposite, by mounting spacer 84 in a lower round aperture 91 at another end, endless track belt 20 has a substantially flat shape at that end. An endless track belt 20 having a C-shape is more maneuverable while an endless track belt 20 that is substantially flat gives better performance since it has a wider supporting footprint.

It is also possible to adjust the tension of endless track belt 20 with a tension adjusting assembly. As it can be seen from FIGS. 2, 3, 10, and 12, one end of inside and outside mounting plates 70, 72 includes several slotted apertures 92, one slotted aperture 92 for each round aperture 91. Slotted aperture 92 receives a fastener 94 used to rotatably mount the wheels 28 to the assembly. By sliding the fastener 94 in the slotted aperture 92, it is possible to increase or decrease the tension on the track belt 20. To adjust and maintain the track tension, a cam element 96, having an outer periphery provided with notches 98 located at different distances from the attachment point of the cam element 96, is mounted to the fastener 94. By selecting which notch 98 is in contact with a fixed pin (not shown) of the cam element 96, a predetermined tension may be maintained. It is to be noted that the cam element 96 can be provided with a handle (not shown) to facilitate the manipulation by a user. It is also understood that the tension adjusting assembly can be located at the opposite end of the inside and outside mounting plates 70, 72.

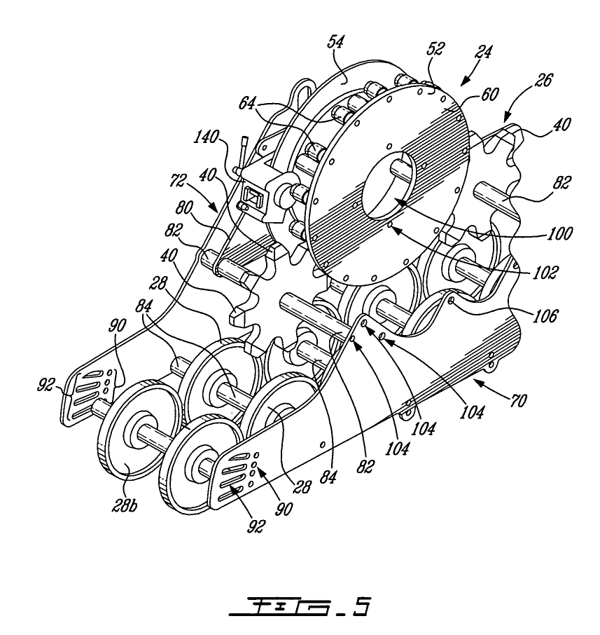

Inside mounting plate 70 has a central aperture 100 (FIG. 5) for inserting conventional hub 50 of the all-terrain vehicle 10 therein. It also has small apertures 102 all around the central aperture 100 for inserting fasteners (not shown) therein for fastening the track assembly 14 to the vehicle 10.

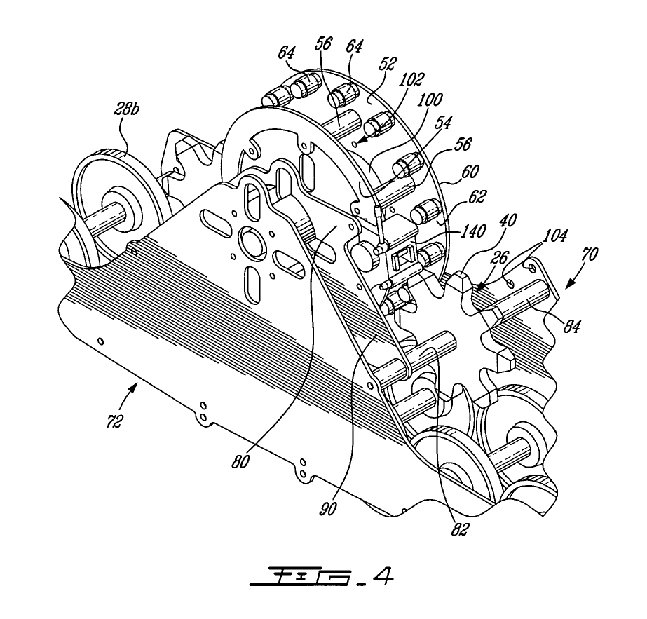

It is possible to adjust the height of the track assembly 14 by modifying the position of driving track wheels 26 relatively to main driving wheel 24. As it can be seen from FIG. 4, inside and outside mounting plates 70, 72 are provided with a plurality of round apertures 104 in which spacer 82 can be fastened with fasteners 86. A round aperture 104 on inside mounting plate 70 faces a corresponding round aperture 104 on outside mounting plate 72. By fastening spacer 82, on which driving track wheel 26 is rotatably mounted, in different round apertures 104, the height of track assembly 14 is modified. Inside and outside mounting plates 70, 72 are also provided with a central round aperture 104. If track assembly 14 only has one track driving wheel 26 operatively engaged with the main driving wheel 24 and the longitudinal track driving belt 20, spacer 82, on which the single driving track wheel 26 is rotatably mounted, is preferably fastened with fasteners 86 in central round aperture 106 (FIG. 2). However, with two driving track wheels 26, the vehicle rolling is smoother.

The track assembly 14 also allows to replace any of the driving wheels 24, 26 with another wheel having a different diameter. Changing the driving wheels 24, 26 allows to modify the gear ratio of the vehicle 10.

It is also possible to cover the external gearing of the track assembly 14, which includes main driving wheel 24 and driving track wheels 26, with a protective cover (not shown). The protective cover prevents the insertion of undesired objects, such as branches, in the track assembly 14 and further acts to reduce the security risk associated with operating such a track assembly 14, for the vehicle's user or any other person in proximity of the track assembly 14.

As stated hereinabove, the track assembly 14 is provided with an external gearing, i.e. the main driving wheel 24 and the track driving wheel are located externally of endless track belt 20. The endless track belt 20 has a plurality of equidistant openings 36 separated by bridging webs 38, which ensure a positive engagement with the teeth 40 provided on the outer circumference of track driving wheels 26. Moreover, the main driving wheel 24 is provided with a plurality of equidistant engaging members 64, which ensure a positive engagement of the teeth 40. In operation, the main driving wheel 24 is coupled to a drive shaft, via the hub 50, connected to an engine (FIGS. 2, 7, and 8), in such a way that the engine drives the main driving wheel 24 in rotation. The main driving wheel 24 thus drives both track driving wheels 26 in rotation by meshing engagement of the teeth 40 and the equidistant engaging members 64. The track driving wheels 26 drives the endless track belt 20 in rotation by the meshing engagement of the teeth 40 with the equidistant openings 36 separated by bridging webs 38 of the endless track belt 20. It is further to be understood that the transversal lugs 34 on the external circumference surface of the endless track belt 20 respectively exert a positive mechanical connection with the underlying ground surface that contributes to propel the vehicle 10.

In another embodiment, the track assembly 14 includes a steering mechanism that facilitates the steering of the all-terrain vehicle 10. Referring to FIGS. 3 to 6, it will be seen that the steering mechanism includes two secondary braking systems. Each braking system is operatively associated with a track assembly 14 disposed at the front of the all-terrain vehicle 10, mainly with the main driving wheel 24 of the assembly 14. Each secondary braking system includes a brake 140. The brake 140 is disposed proximate to the main driving wheel 24. In FIGS. 3 to 6, the brake 140 is mounted proximate to the outside plate 54 and abuts against the latter when the braking system associated with the brake 140 is activated. The brake 140 abutting the outside plate 54 slows down the rotation movement of the main driving wheel 24 and consequently the rotation movement of the track belt 20. When the all-terrain vehicle 10 negotiate a turn in a predetermined direction, the braking system associated with the main driving wheel 24 located inside the desired turn can be activated to provide better maneuvering of the vehicle. The main driving wheels 24 of the front track assemblies 14 have therefore a different rotation speed and the vehicle 10 turns in the direction of the main driving wheel 24 having the slowest rotation speed. Moreover, for tracked vehicle, since the rotation pivot is offset relatively to the track belt 20, the vehicle steering is even more facilitated.

The steering mechanism can be activated manually with a handle, a pedal, or the like or automatically while turning the steering of the vehicle. The steering mechanism can be combined with the main braking system of the vehicle without departing from the scope of the invention. Each braking system can be operatively associated simultaneously with a front and a rear driving wheels on the same side of the vehicle 10. Brakes 140 can be operatively associated with the track driving wheels 26, on the inside plate 52 of the main driving wheel 24 or both inside and outside plates 52, 54 without departing from the scope of the invention. Preferably, the plate(s) or wheel(s) associated with each brake 140 is made in steel or any other appropriate material.

Of course, one skilled in the art could design another arrangement of the mounting assembly of the endless track belts 20 to the vehicle 10 to obtain this external driving wheel feature without departing from the spirit and nature of the present invention.

Alternatively, the track assembly 14 could only be comprised of a main driving wheel 24 directly engaged with the longitudinal track driving belt 20. In that case, the main driving wheel 24 would be provided with equidistant teeth 40 on its periphery for meshing engagement with either the transversal lugs 34 and/or the equidistant openings 36 separated by bridging webs 38. Furthermore, the motor of the all-terrain vehicle 10 preferably turns in the opposite direction.

As people in the art will understand, the all-terrain vehicle of the present invention, provided with four endless track assemblies, can be used for a wide range of operations and terrain, while being highly mobile and offering good running performance. The endless track structure maintains an adequate configuration over a variety of surfaces. Since it does not have sliding shoes, it can be used on any ground surface.

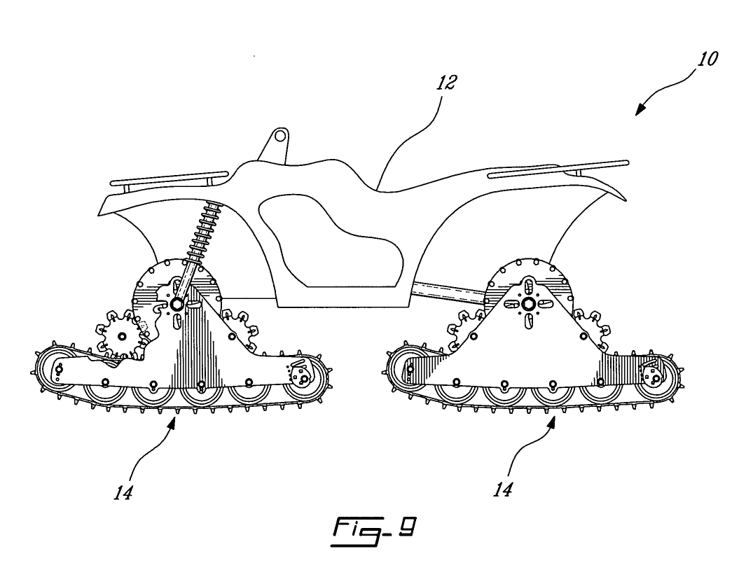

Moreover, the track assembly 14 can be used with all-terrain vehicle 10 of any cylinder capacity. As it can be seen in FIGS. 1 and 9, the track assembly 14 provides support longitudinally under almost the entire all-terrain vehicle 10, including under the lower portion 120 of the vehicle 10. It provides a wide supporting footprint that performs adequately in deep snow conditions. The snow projected on the driver while using an all-terrain vehicle 10 having the track assembly 14 is negligible. Moreover, as it can be seen in FIGS. 1 and 9, the wings of the all-terrain vehicle 10 are clear from the track assemblies 14. Therefore, even if the track assembly 14 pivots around hub 50, the risk of interference with the wings is negligible.

Referring back to FIGS. 1, 7, 8, and 10-12, it will be seen that either the vehicle 10 or the track assembly 14 can have a rotation stopper 130 that stops the rotation movement of track assembly 14 around hub 50. In one embodiment, rotation stopper 130 is mounted on spacers 84 with fasteners 132 and proximate to inside mounting plate 70. Rotation stopper 130 has a slot 134 in the middle therein. Vehicle 10 is provided with a member 136 (FIGS. 10-12) having a portion slidably inserted in slot 134 and another portion mounted on the vehicle 10. The rotation movement of track assembly 14 stops when the member 136 abuts one end of slot 134. Rotation stopper 130 prevents the track assembly 14 to enter in contact with a vehicle wing and spoil the latter.

It will be obvious to people skilled in the art that the present invention can be applied both in the case of a two-wheel drive vehicle wherein the power is typically applied only to the rear track belt assemblies and the front track assemblies merely facilitate steering, and in the case of a four-wheel vehicle, wherein power is independently provided to each one of the four track assemblies. It is also understood that, although the present invention has been described in the context of a four-wheeled all-terrain vehicle (ATV), it could also be applied to other vehicles including various straddle-type vehicles, such as dirt bikes, motorcycles and three-wheeled ATV.

As will be further understood by one skilled in the art, the all-terrain vehicle 10, equipped with track assemblies according to the present invention, may be viewed as a snow vehicle since it may be used on snow as efficiently as conventional snow vehicles such as snowmobiles, for example. The wide supporting footprint of the track assemblies is an important factor allowing this good performance. However, the absence of sliding shoes allows the use of the all-terrain vehicle on harder surface without the usual drawbacks of tracked vehicles.

Interestingly, the present track assembly system can equip all four wheels of an all-terrain vehicle or only the front or rear wheels thereof. A further possibility would be to use track assemblies according to the present invention in place of the rear wheels of a vehicle, while mounting skis in place of the front wheels thereof. Another important advantage of the track assembly 14 is that the same track assembly 14 can be mounted in any position on the vehicle (front, rear, left and right).

The embodiments of the invention described above are intended to be exemplary only. The scope of the invention is therefore intended to be limited solely by the scope of the appended claims.

We claim:

1. A track assembly for an all-terrain vehicle comprising:
a longitudinal endless track belt having an outer surface and an inner surface; and
a mounting structure to mount said longitudinal endless track belt to said vehicle, said mounting structure including
at least one driving wheel disposed externally to said longitudinal endless track belt, said at least one driving wheel being in driving engagement with said longitudinal endless track belt; and
at least two inner wheels in contact with said inner surface of said longitudinal endless track belt.

2. A track assembly as claimed in claim 1, wherein said longitudinal endless track belt is in meshing engagement with teeth provided on said at least one driving wheel.

3. A track assembly as claimed in claim 2, wherein said meshing engagement is provided by said teeth engaging with transversal lugs provided on said outer surface of said endless track belt.

4. A track assembly as claimed in claim 1, wherein said at least two inner wheels are idler wheels.

5. A track assembly as claimed in claim 1, further comprising a tension adjusting assembly for adjusting the tension of said endless track belt.

6. A track assembly as claimed in claim 1, further comprising a vertical position adjusting means for said inner wheels such that a shape of said longitudinal endless track belt may be modified.

7. A track assembly as claimed in claim 1, wherein said at least one driving wheel is adapted to be drivingly connected to the driving output of the straddle type vehicle for transmitting power to said endless track belt.

8. A straddle-type vehicle including at least one track assembly to support said vehicle onto a ground surface, said at least one track assembly comprising:
a longitudinal endless track belt having an outer surface and an inner surface;
a frame to mount said longitudinal endless track belt to said vehicle;
at least one driving wheel disposed externally to said longitudinal endless track belt, said at least one driving wheel being in driving engagement with said longitudinal endless track belt; and
at least two inner wheels in contact with said inner surface of said longitudinal endless track belt.

9. A straddle-type vehicle as claimed in claim 8, wherein the straddle-type vehicle is selected from a group consisting of: a dirt bike and a all-terrain vehicle.

10. A straddle-type vehicle as claimed in claim 8, wherein said endless track belt is in meshing engagement with teeth provided on said at least one driving wheel.

11. A straddle-type vehicle as claimed in claim 10, wherein said meshing engagement is provided by said teeth engaging with transversal lugs provided on said outer surface of said endless track belt.

12. A straddle-type vehicle as claimed in claim 8, wherein said inner wheels are idler wheels.

13. A straddle-type vehicle as claimed in claim 8, wherein said driving wheel is mounted to a hub of said all-terrain vehicle.

14. A straddle-type vehicle as claimed in claim 8, wherein said at least one track assembly is part of a pair of front track assemblies and wherein said vehicle further comprises:
at least one independent braking system operatively connected to said at least one driving wheel; the braking systems of said track assemblies being selectively independently actuable,
whereby upon actuating one of said braking system, said driving wheel operatively associated with said actuated braking system slows down allowing said vehicle to turn in the direction of said slowed down driving wheel.

15. A mechanism for facilitating the steering of an all-terrain vehicle having a pair of track assemblies, each track assembly having at least one driving wheel, the mechanism comprising at least one first and second braking systems operatively connected to respective driving wheels of said pair of track assemblies; said first and second braking systems being independently actuable, whereby upon activating one of said first and second braking systems, the driving wheel operatively associated with said actuated braking system is slowed down to facilitate turning of the vehicle in the direction of the slowed down driving wheel.

16. A mechanism as claimed in claim 15, wherein said first and second braking systems form part of a secondary braking system of the vehicle.

17. A mechanism as claimed in claim 15, wherein each of said first and second braking systems comprises:
a braking member positioned proximate to said driving wheel; and
an actuator to activate said braking member; and
whereby, upon activating said actuator, said braking member abuts said driving wheel and slow down the rotation movement of said driving wheel.
